(19) United States
(12) Patent Application Publication
(10) Pub. No.: US 2021/0297591 A1
(43) Pub. Date: Sep. 23, 2021

(54) Omni-Directional Camera with Fine-Adjustment System for Calibration

(71) Applicants: Victor Bélanger-Garnier, Montreal (CA); Jason Carl Radel, Montreal (CA)

(72) Inventors: Victor Bélanger-Garnier, Montreal (CA); Jason Carl Radel, Montreal (CA)

(21) Appl. No.: 16/823,467

(22) Filed: Mar. 19, 2020

(51) Int. Cl. H04N 5/232; H04N 5/225; G06T 3/40

(52) U.S. Cl. CPC H04N 5/23238; G06T 3/4038; H04N 5/2258

(57) ABSTRACT

A multi-sensor omnidirectional camera or cameras where the virtual center of projections of the cameras are controlled using movable reflective surfaces. The virtual center of projections can be placed in closer proximity to one another than would otherwise be possible due to physical space limitations. In addition, the reflective surfaces can be controlled in such a way as to offset or compensate for different camera displacements and rotations in order to achieve a configuration where high fidelity to a natural field-of-view is attained. This proves beneficial in virtual reality applications where a high level of visual fidelity is necessary for full immersion.

### CROSS-REFERENCE TO RELATED APPLICATIONS

This application claims benefit of U.S. provisional patent application No. 62/825,401, filed Mar. 28, 2019, the specification of which is hereby incorporated herein by reference in its entirety.

### BACKGROUND OF THE INVENTION

Large field of view recording and streaming requires multiple cameras. The images or videos from these cameras must be “stitched” into a single, seamless image for viewing in display devices. This stitching is commonly done via image processing, but this processing makes live streaming difficult, especially at high framerates and high resolutions.

An alternative is to achieve image stitching physically. This can be achieved by using an apparatus with cameras and the ability to adjust these cameras to place the cameras in a position where the video from these cameras is stitched or nearly stitched into a single image with no active image processing required. However, physical limitations prevent cameras from being able to record from the same point; each camera must be physically separated due to their size, which prevents the recording of seamless video of imagery including objects covering a range of depths, unless using active image processing.

### BRIEF SUMMARY OF THE INVENTION

A large field of view recording apparatus that uses an array of cameras to record and/or stream seamless, large field of view video with little-to-no image processing. Each camera records video reflected from one or more mirrors. The location and orientations of the cameras and mirrors are calibrated to provide a seamless image over a large depth range with little-to-no image processing required. This invention is a significant advancement over existing multiple camera recording devices due to the reduction in image processing required for live, high resolution footage from these cameras to be viewed in virtual reality or on any display device with minimal latency. This invention, when combined with a large field of view display device such as virtual reality headsets or immersive environments, can be used with drones to provide first-responders with up-to-date information from an emergency scene, or aid emergency personnel in search and rescue operations.

### BRIEF DESCRIPTION OF THE SEVERAL VIEWS OF THE DRAWINGS

FIG. 1 depicts a top-view representation of a multi-camera [110] embodiment, where the reflective surface [120] rotates about an axis perpendicular to the plane of the drawing. This rotation moves [130] the virtual center of the camera [140] to calibrate its position.

FIG. 2 depicts a side-view representation of a single camera [210] in a multi-camera embodiment where the reflective surface is rotated about an axis perpendicular to the plane of the drawing [220], adjusted to calibrate the vertical angle [230] and where the distance to the camera [240] is adjusted to calibrate the distance [250] of the virtual center [260].

FIG. 3 depicts a side-view representation of a single camera [310] in a multi-camera embodiment where two reflective surfaces are used [320]. The horizontal displacement of the first reflective surface [330] is adjusted to calibrate the horizontal position of the virtual center [340]. The vertical displacement of the second reflective surface [350] is adjusted to calibrate the vertical position of the virtual center [360]. The vertical tilt of both reflective surfaces [370] are adjusted to calibrate the vertical angle [380] of the virtual center [390].

FIG. 4 depicts two camera frustums [410] that coincide along a middle line [420]. A calibration distance is chosen [430], and the corresponding overlap angle [440] is removed from the camera's field of view [450]. A portion of the overlap angle can be kept to facilitate image processing [460].

FIG. 5 depicts the geometrical intersection between a panoramic projection [510] and the camera frustums [520] describing a characteristic curve [530]. Correctly mapping the camera frustums to their corresponding panorama coordinates is part of the pre-processing that can be contained in a fixed “pixel mapping”.

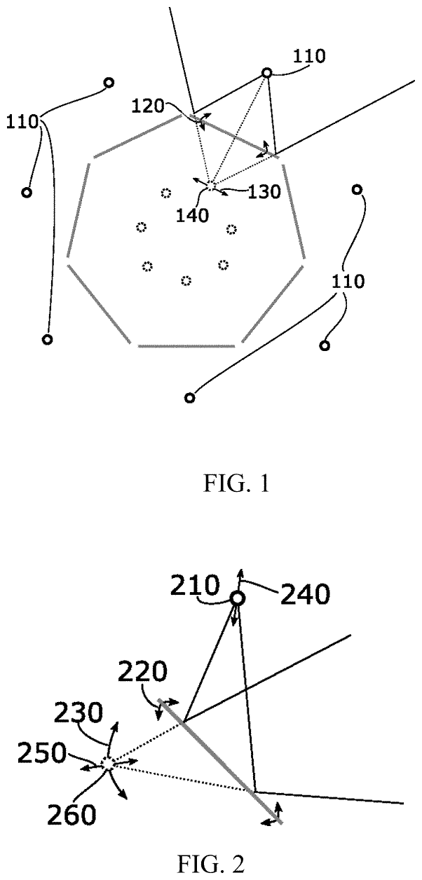

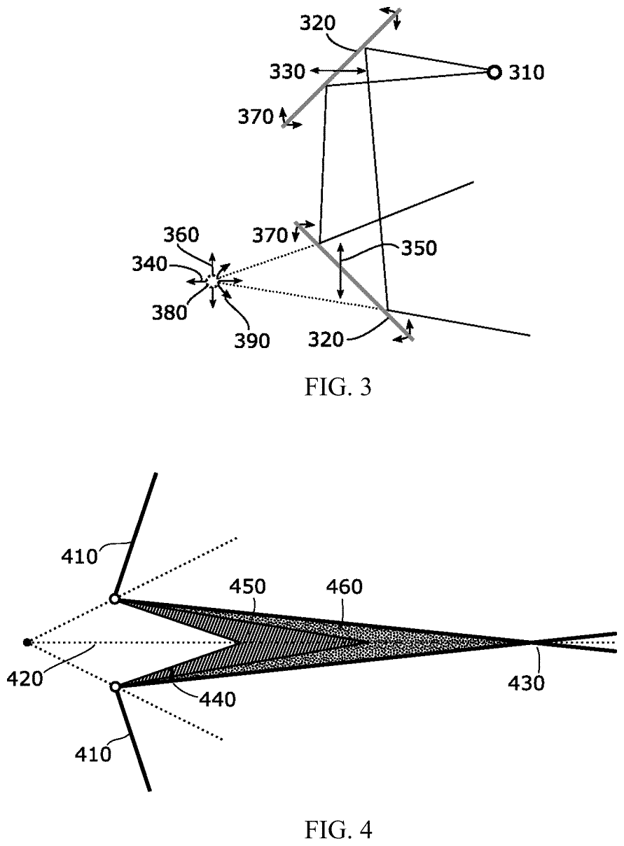

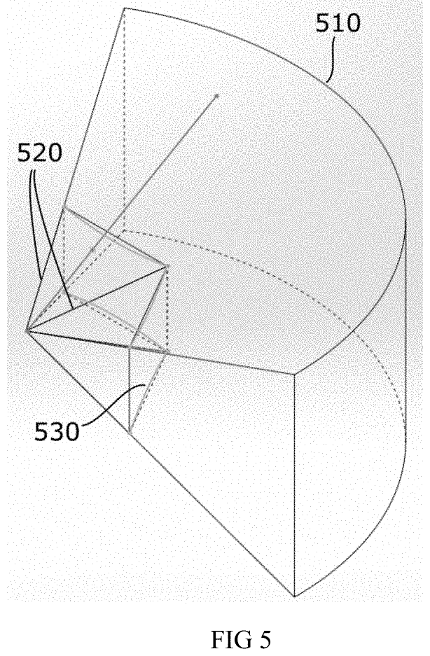

### DETAILED DESCRIPTION OF THE INVENTION

Virtual reality provides people with a natural way to experience and interact with 3D imagery. Modern virtual reality nearly always uses pre-processed 3D scenes, such as those built for games or video recorded and processed for viewing. It is now becoming possible to view live footage, which is opening up new applications for virtual reality. For example, live footage of a disaster taken from a drone can assist first responders in emergencies, or as surveillance to locate lost or missing persons. Effective use of this technology requires live-streaming video with a large field of view, minimal latency, and high resolution.

Omni-directional cameras can typically take three forms: a single camera with curved reflective surfaces, one or two cameras with fish-eye lenses, or multiple-camera systems. A curved reflective surface can be used to capture a very large field of view, but the image is distorted based upon the curved surface. Additionally, any one or two camera system can only record the number of pixels measured in the camera's sensors. The resolution of the human eye is roughly 50 pixels per degree in its center of view, thus for video meant to be viewed by human beings, it would be ideal to record video at a resolution of at least 50 pixels per degree. However, this equates to 18,000 pixels in the horizontal direction alone. Even 4k sensors typically have no more than 3,840 in recording sensors in the horizontal direction. For this reason, video recording at 360° usually involves either low angular resolution recording, or using many cameras recording simultaneously, all pointed in different directions.

Multiple camera recording arrangements can record video at extremely high resolution, but in order to be viewed in virtual reality, the recorded video must be processed so that the videos from each camera are stitched into a single, seamless image. The time required to process this video is large enough that live viewing of a stitched, seamless image is extremely difficult.

The invention described here is a physical camera arrangement designed to eliminate this computationally-intensive image processing. Instead, the stitching of the image is done using an array of cameras, each directed into a mirror or set of mirrors designed to be oriented in such a way as to stitch the video from each camera into a single seamless or nearly-seamless image.

Correct physical stitching requires three components: an array of cameras recording a field of view chosen appropriately for their arrangement, a common or nearly-common center of projection, and a calibration system for fine physical alignment of the cameras.

Correct field of view matching requires the determinations of the orientation of each camera and a camera lens in order to ensure the video from one field of view will match closely with the field of view of the next camera. For example, nine cameras can be placed on a ring and directed outward. If each camera records 40° horizontal field of view, then one camera video feed will match closely with the next. In this arrangement, a pre-determined texture mapping of this video onto a spherical surface will be necessary to create a seamless image, but this pixel mapping can be set up beforehand, and so can readily be applied in real-time, unlike image processing using active feature recognition. Practically, lenses on cameras will not precisely provide the correct field of view, but cropping of captured video can also be done at this time. Again, this pre-determined processing can readily be done in real-time.

A common or nearly common center of projection of each camera is necessary in order to provide physical stitching over a large depth of field. Without a common center of projection, there will be gaps in the recorded image if the fields of view are matched. Alternatively, excess field of view can be used for each camera to cover this gap, however then the recorded imagery will have an overlap that changes based on how far away the recorded objects are. The only way to record to avoid this issue is to have the cameras record from the same location, but directed in different directions. However, physical limitations prevent cameras from being placed in the same location. By using reflective surfaces, however, it is possible to get past this limitation by minimizing the inter-distance between each camera's virtual center of projection rather than the physical center of projection. Proper depth of field recording is important in scenarios such as first-responder assistance, where correct visualization is necessary for objects that are far away for navigating to the scene, and also for objects that are in close proximity, for navigation around obstacles.

Finally, in order to record seamless video, the orientations of the cameras must be incredibly precise. For cameras recording HD video over a 40° field of view, a mis-orientation of a camera by only 0.02° is sufficient to create pixel misalignment in the captured video. Therefore, an extremely precise calibration system is required in order to achieve proper alignment between cameras. This can be difficult to do with large, cumbersome cameras, but can be performed far more readily with simple mirrors. In this invention, each camera captures video from finely movable mirrors, where the mirror orientations are pre-calibrated to achieve precise physical alignment.

Nearly all multiple-camera recording devices rely on extensive image processing to achieve a seamless image. For example, feature-based matching. However, such heavy computations can prohibit the displaying of video in real-time. This is a problem when real-time intervention from an operator is desired. For this kind of scenario, it is preferred to have a fixed “pixel mapping” between the omni-directional camera and the display. The “pixel mapping” usually correspond to a very precise optical configuration.

The present invention aims to give a way to adjust, with precision, the optical configuration of an omni-directional camera system while allowing for a large depth of field by minimizing the distance between virtual centers.

1. Physical calibration system for at least two light capturing devices using movable reflective components
a. Where reflective components are oriented to reflect light through at least two or more light entrance pupils and into light capturing devices.
b. Where the virtual center of projection of the light capturing devices are located at or near the same location
c. Where light captured from all cameras requires no active image recognition algorithms for large field of view recording or streaming.
d. Where a fine-adjustment apparatus is attached to the reflective components to allow precise mechanical calibration

2. Embodiment of claim 1, where a prism is used to obtain an asymmetric field of view

3. Embodiment of claim 1, where a lens is used after the reflective surface to reduce the size of the reflective surface.

4. Embodiment of claim 1, where a computing device is used to apply the image corrections in real-time. Device may be located at a secondary location.

5. Embodiment of claim 1, where a recording device saves into memory the video content.

6. Embodiment of claim 1, where a real-time transmitting device is used to transmit the video information to a base station for live streaming.

7. Embodiment of claim 1, where a protective and/or decorative housing is added to protect and/or decorate the apparatus.

8. Embodiment of claim 1, where the complete apparatus is light-weight, meant to be carried by a low-load vehicle. Example of vehicles include small-size land rovers and unmanned aerial vehicles.

9. Embodiment of claim 1 where vibration and shock-resistant materials and techniques are used on the fine-adjustment apparatus. This includes, but is not limited to, thread-locking fluids.

10. Embodiment of claim 1, where two or more reflective components with precision alignment are used for each camera to provide six or more degrees of freedom in the alignment

11. Physical calibration system for projector(s) or other light emitting devices using movable reflective components
a. Where reflective components are oriented to project light from light emitting devices
b. Where virtual images of light emitting devices are located at or near the same location
c. Where light emitted from light emitting devices requires minimal processing for large field of view playback or streaming
d. Where a fine-adjustment apparatus is attached to the reflective components to allow precise mechanical calibration

12. Embodiment of claim 11, where a prism is used to obtain an asymmetric field of view.

13. Embodiment of claim 11, where a lens is used after the reflective surface to reduce the size of the reflective surface.

14. Embodiment of claim 11, where a computing device is used to apply the image corrections in real-time.

15. Embodiment of claim 11, where a playback device loads the video content from memory.

16. Embodiment of claim 11, where a real-time transmitting device is used to transmit the video information to a base station for livestreaming.

17. Embodiment of claim 11, where a protective and/or decorative housing is added to protect and/or decorate the apparatus.

18. Embodiment of claim 11 where vibration- and shock-resistant materials and techniques are used on the fine-adjustment apparatus. This includes, but is not limited to, thread-locking fluids.

19. Embodiment of claim 11, where two or more reflective components with precision alignment are used for each camera to provide six degrees of freedom in the alignment.
